(19) United States
(12) Patent Application Publication
(10) Pub. No.: US 2010/0211885 A1
(43) Pub. Date: Aug. 19, 2010

(54) QUICK DESIGN USER PROFILES FOR IMPROVING DESIGN TIME OF PERSONALIZED PRODUCTS

(75) Inventors: Joshua M. Berg, Cambridge, MA (US); Brandon S. Williams, Revere, MA (US); Osi M. Peters, Brockton, MA (US)

Correspondence Address: VISTA PRINT USA, INC.;ATTN: PATENT COUNSEL, 95 HAYDEN AVENUE, LEXINGTON, MA, 02421, US

(73) Assignee: VistaPrint Technologies Limited

(21) Appl. No.: 12/389,301

(22) Filed: Feb. 19, 2009

(51) Int. Cl. G06F 3/048

(52) U.S. Cl. 715/745

(57) ABSTRACT

QuickDesign User Profiles allowing users to store personalized information for auto-population of template designs when the user visits a website to design personalized products.

### FIELD OF THE INVENTION

The present invention relates to online product design systems, and more particularly to a quick design user profile for improving design time of customized products.

### BACKGROUND OF THE INVENTION

Customized and personalized products can be ordered over the Internet from online websites such as www.VistaPrint.com, which provide a plurality of template designs for selection by a user. Such template designs include content that can be customized by the user, for example as to choices in color scheme, font selections, layout, and image and text content. After selection of a template design) editable text and image content can be personalized with information personal to the particular user designing the product. After editing the editable content, the product design can be saved and physical products having the design printed or otherwise incorporated onto the product can be ordered and subsequently manufactured.

In these types of template designs, the user must edit each of the editable fields for every design that the user wants to create. However, much of the editable field information that a particular user enters will often be identical from design to design, and thus designing multiple products can be a tedious process.

### SUMMARY

The present invention is directed to systems and methods that provide automated generation of a montage of images of matching products.

In an embodiment, a computer implemented method for allowing users of one or more design tools at a website to store a user profile for auto-population of customizable data containers of design templates, includes: providing a user profile storage control on a web page which, when activated by a user of the website, displays a plurality of fields having associated editable field values which may be incorporated into one or more electronic template designs, and which allows the user to edit the editable field values to include personalized information and to save the edited fields as a user profile associated with a user account; and storing one or more user profiles created using the user profile storage control such that when a user returns to the website, the user may select to utilize a stored user profile associated with the user account such that upon selection of an electronic template design comprising a design of a product that incorporates one or more fields, the incorporated fields corresponding to fields in the selected user profile are automatically populated with the corresponding field values and an image of the populated product template design is displayed to the user on a computer display.

In another embodiment, a computer implemented method for automatically populating fields in an electronic template design displayed on a web page of a website in a browser executing on a user's computer, a server hosting website associating the user with a user account, includes: displaying a template design, the template design comprising a plurality of fields having corresponding editable field values; and providing a user profile import control on a web page which, when activated by the user, displays one or more available user profiles associated with the user's account and which receives a selection of one of the available user profiles and automatically and without further action by the user populates fields of the template design with field values of corresponding fields of the selected user profile.

Other embodiments include, but are not limited to, computer readable storage media storing computer readable instructions which, when executed by a processor, implement the above methods. Still other embodiments include, but are not limited to, servers, clients, and systems which implement the above methods.

### BRIEF DESCRIPTION OF THE DRAWINGS

FIG. 1 is a block diagram of a computer system with which the invention may he employed.

FIGS. 2-10 show a sequence of screen shots that a user might encounter when ordering a customized product from an online vendor of customized products and utilizing the Quick Design User Profile tools.

FIG. 11 is a flowchart illustrating an exemplary embodiment of a method of operation of a Quick Design User Profile tool.

### DETAILED DESCRIPTION

Web-based providers of custom products, taking advantage of the capabilities of the World Wide Web and modern Web browsers, operate Web sites that provide online design services for user's desiring to create customized materials from any computer with web access at whatever time and place is convenient to the user. These service providers typically provide their customers with the ability to access the service provider's Web site, view product templates, and use software tools provided by the site to select a template, add images, text, or other content, and perform various modifications to create a customized product design. After the product has been designed by the user, Web-based service providers also typically allow the user to place an order for the production and delivery to the user's home or business of quantities of high quality, printed products of the type that the user is not capable of producing with the printer systems typically connected to most personal computer systems.

One network-based product design system is disclosed in co-owned U.S. Pat. No. 6,650,433, issued Nov. 18, 2003 and entitled “Managing Print Jobs”, which is hereby incorporated by reference in its entirety. The system discloses a downloadable editing tool that allows a customer to create and edit WYSIWYG (“what you see is what you get”) markup language documents in the customer's browser. The system makes a number of pre-designed product templates available for customer viewing, downloading, and customizing. The customer can upload the electronic document to a server and place an order for production of the printed products.

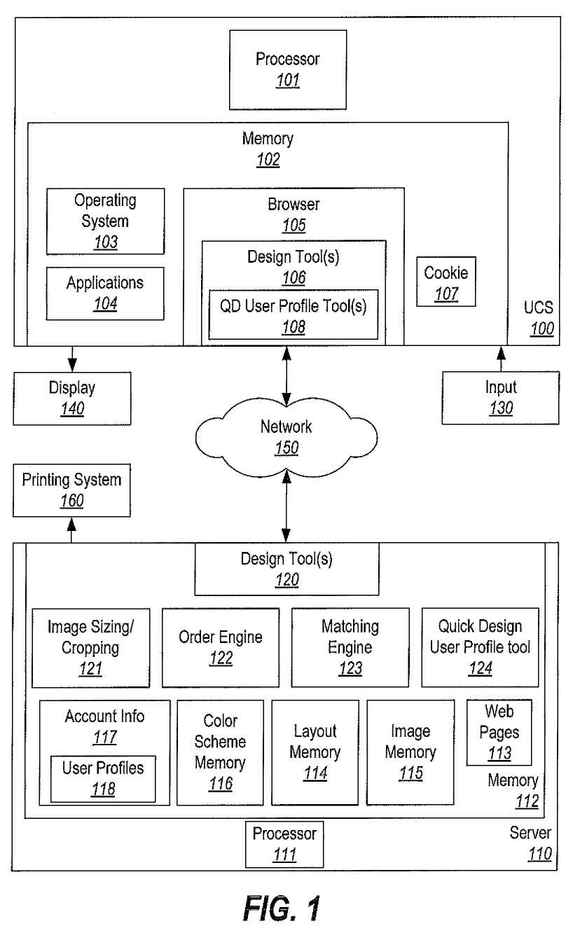

For example, referring now to FIG. 1, an exemplary user computer system UCS 100 includes processor 101 and memory 102. Memory 102 represents all UCS 100 components and subsystems that provide data storage, such as RAM, ROM, hard drives, and removable storage media such as, but not limited to, CD-ROMs, floppy discs, memory sticks, etc. In addition to providing permanent storage for all programs installed on UCS 100, memory 102 also provides storage required by the operating system 103 and the applications 104 while they are executing. In a preferred embodiment, UCS 100 is a typically equipped personal computer, but UCS 100 could also be a portable computer, a tablet computer or other device. The user views images from UCS 100 on display 140, such as a CRT or LCD screen, and provides inputs to UCS 100 via input devices 150, such as a keyboard and a mouse.

When UCS 100 is operating, an instance of the UCS 100 operating system will be running, represented in FIG. 1 by operating system 103. In addition, the user may be running one or more application programs. In FIG. 1, UCS 100 is running Web browser 105, such as Internet Explorer from Microsoft Corporation. Other applications that may be running in UCS 100, such as spreadsheet, e-mail, and presentation programs, are represented as applications 104. When a user accesses the website served by the server 1107 the server 110 serves web pages 113 to the browser 105 executing at the UCS 100. The server may store a cookie 107 on the UCS 110 so that when the user returns to the website at a later date, the server can customize some features of the web pages to the user's preferences (which are obtained as the user navigates the website). The use of cookies is well known in the art.

Design tool 106 runs in browser 105 and allows the user to prepare a customized product design in electronic form. In an exemplary embodiment, design tool 106 is a product design program downloaded to UCS 100 via network 150 from remote server 110. Alternatively, design tool 106 could have been obtained by the user from memory 102 or from another local source. When the user is satisfied with the design of the product, the design can be uploaded to server 10 for storage and subsequent production of the desired quantity of the physical product on appropriate printing 160 and post-print processing systems. As will be discussed in more detail below, in an embodiment the user creates a custom product design by adding personalized information or other content to a previously designed template prepared by the vendor or service provider. Each template is conceptually a combination of one or more graphics, images, text, fonts, color schemes arranged according to a layout and includes fields that may be personalized with user information.

While server 110 is shown in FIG. 1 as a single block, it will be understood that server 110 could be multiple servers configured to communicate and operate cooperatively. Memory 111 represents all components and subsystems that provide server data storage, such as RAM, ROM, and disk drives or arrays, and removable storage media such as, but not limited to, CD-ROMs, floppy discs, memory sticks, etc. Web page memory 113 stores all of the web pages of the vendor website. Template layout memory 114 represents the portion of memory 111 that contains the XML layout descriptions of the design templates. Each layout specifies the size, position and other attributes of all product elements such as text containers, image containers, graphics, z-index values and so forth. For each different type of product, layouts are provided that combine different numbers of image and text containers in different sizes and arrangements.

In an embodiment, image memory 115 represents the portion of memory 111 that contains the images and related image attributes, such as the image size, the default color scheme associated with the image, and one or more keywords that have been associated with that image by the vendor. Color scheme memory 116 contains the set of color schemes for use in generating templates. A color scheme is a set of pre-selected complementary colors, usually from three to five, pre-selected by the service provider to be applied as a group in a template design. Instead of assigning a fixed color to each template element having a color attribute, each such element in the template will be associated with one of the component positions in whichever color scheme has been selected for use with the template. Account information memory 117 stores information associated with user accounts, such as account holder information, order history, portfolio of saved product designs, and user profiles 118.

Design support tool(s) 120 provide server-side support to the design tool(s) 106 operating in the user's browser 105. Image sizing/cropping 121 represents the software tools that receive image container size information from template layout memory 114 and image information from image memory 115 and, if possible within established constraints, perform the image resizing and cropping operations to generate one or more image versions of the appropriate sizes for incorporation into one or more identified layouts.

An order engine 122 executes on the server 110 (as shown), or executes remotely but is in communication with the server 110, and operates to manage the ordering and checkout process when a user is ready to submit an order of a customized product design to the vendor. A matching engine 123 executes on the server 110 (as shown), or remotely but in communication with the server 110, and operates to select, and generate images of customized matching products. The selected set of products may be related to the product associated with the customized product design that was created by the user using design tool(s) 106, or may be selected randomly, pseudo-randomly, or by way of a more complicated algorithm. A Quick Design User Profile tool 124 supports the addition, modification, and deletion of user profiles associated with user accounts, and application of a selected user profile to a currently selected design template, as described in further detail hereinafter.

In an exemplary embodiment, each of the operating system 103, application programs 104, Web browser 105, and design tool(s) 106 on the UCS 100, and each of the design tool(s) 117, order engine 118, image sizing and cropping tool 119, matching engine 120, and Quick Design User Profile tool 121 on the server 110, are embodied as computer readable program instructions stored on one or more computer readable medium(s) 102/112 that are executed by a processor 101/111 to provide their intended functionalities.

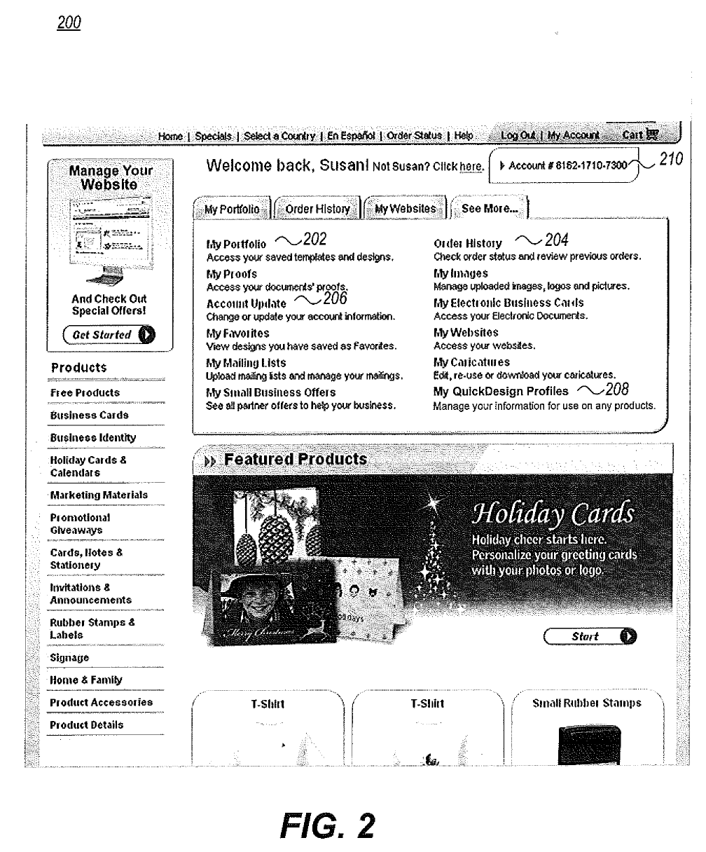

FIGS. 2-10 show a sequence of screen shots that a user might encounter when ordering a customized product from an online vendor of personalized products through a website implementing an exemplary embodiment of a Quick Design User Profile tool. FIG. 2 shows a Welcome Page 200 displayed in a browser window to a user returning to the website from a previous visit. During a previous visit to the site, the website server 110 stores a cookie 107 on the user's computer (UCS) 100. As known in the art, a cookie is information (control data typically in the form of text) sent by a website server to a client such as a user's browser and stored on the user's computer. Each time the user accesses the website using that particular computer 100, the contents of the stored cookie 107 are sent back to the server 110. As illustrated in FIG. 2, the Welcome Page 200 displays a number of options available to a returning user, including controls (e.g., links) for displaying the user's current portfolio of product designs 202, the user's order history 204, updating the account information 206, and managing the user's Quick Design User Profiles 208, which allows the user to manage user information for use in the product designs.

As will be described in more detail below, in one embodiment a user arriving at the website for the first time may be assigned an account number 210 which is associated with the cookie 107 stored on the user's computer 100 by the server 110. In this way, the next time the user visits the website, the user is assumed to be the account holder and the server 110 can customize the content of the web pages 113 presented to the user based on information pertaining to the user's preferences that was identified by the server 110 from the account holder's previous visits.

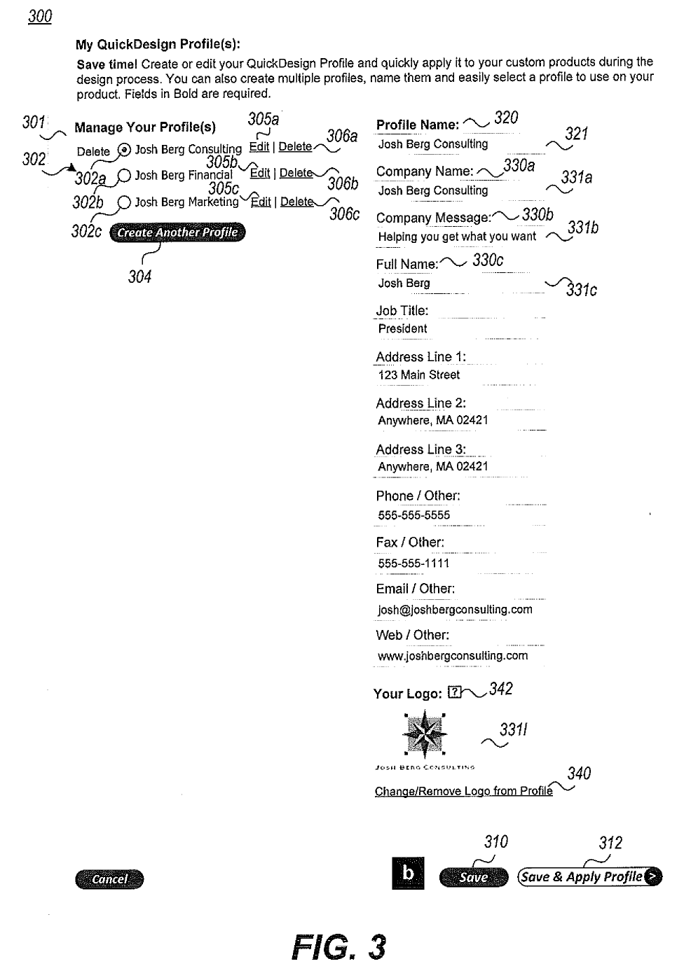

FIG. 3 is a screen shot of a web page 300 presented to the user upon selection of the Quick Design User Profile control 208 from the Welcome Page 200. This page 300 is called the User Profile Data page. The User Profile Data page 300 displays a set of user information assigned as field values to corresponding field names. A field comprises a field name and an associated field value. Fields may be utilized in one or more design templates, discussed hereinafter. In the illustrative embodiment, the field names include “Company Name”, “Company Message”, “Full Name”, “Job Title”, “Address Line 1”, “Address Line 2”, “Address Line 3”, “Phone/Other”, “Email/Other”, “Web/Other”, and “Logo”. In a user profile, a user may supply values associated with the field names. Some field values may be left blank. In FIG. 3, the selected user profile includes values for each of the fields.

In an embodiment, the User Profile Data page 300 includes a profile selector control 301 that lists each of the stored profiles, if any, associated with the account number 210. The profile selector tool 301 allows the user to select one of the profiles from potentially multiple stored profiles associated with the account number 210. If the account number 210 already has associated with it one or more profiles stored on the server 110, in one embodiment the first profile created and associated with the account number 210 is selected by the system by default, and the profile field values displayed on the User Profile Data page 300 are pre-populated with the field values stored in the first profile associated with the account 210. If the user desires to select a different profile associated with the account 210, the user selects the name of the desired profile from the list of profiles 302 displayed by the profile selector control 301. In an embodiment the profile selector control 301 lists the name 302a, 302b, 302c of each profile associated with the account 210 and provides a radio button associated with each profile name. The user can select the radio button associated with the name 302a, 302b, 302c of the desired profile, and the profile selector control 301 changes the selection of the profile to the desired profile, updating all of the displayed field values with the corresponding text saved in the selected desired profile.

Once the desired profile is selected, the user can choose to edit the values of any of the fields associated with the selected profile by clicking on an edit control (e.g., edit link 305a, 305b, 305c), or can choose to delete the profile by clicking on a delete control (e.g., delete link 306a, 306b, 306c). Alternatively, the user can add a new profile to be associated with the account by clicking on an add profile control 304 (e.g., the Create Another Profile button).

FIG. 3 illustrates the User Profile Data Page for a returning user. As illustrated, the field values 321a, . . . , 321l associated with the various profile fields are displayed with each respective field name 320a, . . . , 320l for the selected (either by default or by user selection) user profile. In one embodiment, the field values 321a, . . . , 321l are displayed on the page 300 as editable text boxes which allow the user to edit the field values directly. Any edits to the text boxes may be saved automatically or may require the user to actively request a save prior to updating the previous copy of the user profile. In the illustrative embodiment, the User Profile Data page 300 includes a Save button 310 which, when clicked, saves the profile data (i.e., current field values 321 a, . . . , 321l) associated with the user profile and associates the profile (by value 321 of Profile Name 320) with the account 210. The user profile can be saved either to memory located at the server 110 or to memory located in the account holder's computer system 100 (e.g., as a cookie 107 or configuration file).

In an alternative embodiment the field values 320a, . . . , 320l are read-only and cannot be edited by the user. In this embodiment, the web page 300 includes an edit control 305a, 305b, 305c (such as a button or link) which, when activated, causes the server to update the page 300 with editable text or image containers displaying the field values 320a, . . . , 320l. The user can then edit the field values 320a, . . . , 320l associated with each of the fields. The fields can be defined as text types and the editable text fields can be presented to the user as a text box which allows the user to type directly into the text box to set the value of the corresponding field. For example, a user can change an address associated with the user profile by directly typing the desired address in the text boxes identified by the field names “Address Line 1”, “Address Line 2”, and “Address Line 3”, respectively. Again, any edits to the text boxes may be saved automatically by the design tool(s) 106 or may require the user to actively request a save prior to updating the previous copy of the user profile (for example, by clicking on a Save button 310 present on the web page 300). Again, the user profile can be saved either to memory located at the server 110 or to memory located in the account holder's computer system 100 (e.g., as a cookie 107 or configuration file).

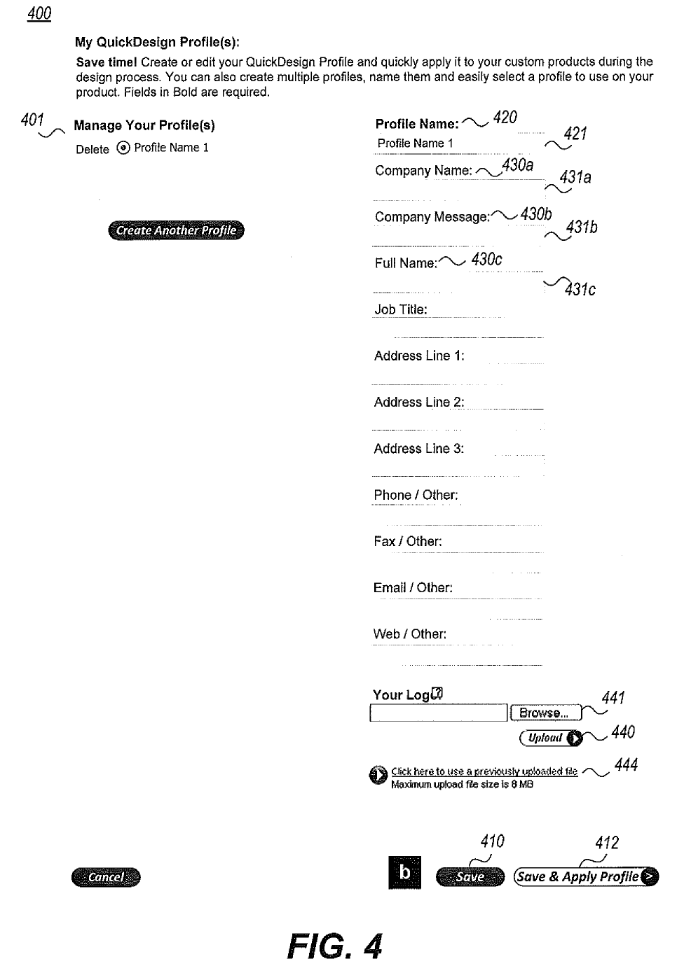

If a user is new to the website and/or has no stored profiles, a New User Data Profile page 400 may be presented to the user upon selection of the Quick Design User Profile control 208 from the Welcome Page 200 (or from any other page that is configured to direct the user to create a user profile). FIG. 4 illustrates an exemplary embodiment of a New User Data Profile page 400. As illustrated, the page 400 includes editable field values 430a, . . . , 430l that can be directly edited by the user. Typically, because no information is yet known about the user, all of the field values 430a, . . . , 430l displayed in the User Data Profile page will be blank, and the user can enter any and/or all of the information he or she wishes to store for future use. Alternatively, if the user is actually a returning user but did not previously store a user profile 118, the server 110 may already have some information about the user based on the user's previous order or browsing history 117 as stored in the server's memory 112 or as a cookie 107 on the user's computer. In this case, the server 110 may know or intelligently guess the values of some of the fields in the profile and may pre-populate the text (and/or image) containers displaying the respective field values 430a, . . . , 430l of corresponding fields on the New User Data Profile page 400. The user may accept these values as correct or may edit them to desired values. Typically, when the New User Data Profile page 400 is displayed, a value 421 for a default profile name 420 (e.g., Profile Name 1) is assigned by the server 400 to the profile 118. This name may be edited by the user to a more descriptive name for later faster profile selection. This is especially useful when the user creates multiple user profiles 118 associated with the user's account number 210.

The user can save changes to a selected profile 118 at any time, typically after making one or more changes or additions to one or more of the text field values and/or uploaded logo image file (discussed below). The user can also save a changed profile as a different profile by changing the value 421 of the Profile Name field to the desired profile name and then saving the profile by clicking on the Save button 410.

The fields of a user profile 118 discussed so far have been identified as being of a text type. However, the invention is not so limited. Fields can be other types as well, including numerical types and image types. For example, as illustrated in FIGS. 3 and 4, the User Profile Data page 300/400 also includes a logo upload control 340/440 that allows a user to upload a logo image to be associated with the selected profile. Thus, the logo field is an image type. The logo upload control 340/440 may include a Browse control 441 that allows the user to browse the user's connected memory locations for locating an image to be uploaded and associated with the profile 118. The logo upload control 340/440 may have a help button 342/442 associated with it which, when clicked, displays a popup window (not shown) describing how to utilize the logo upload control, what file formats are acceptable for the logo, and other useful tips. The logo upload control 340/440 may also include a control, such as a button or link 444, which allows a user to view and select a previously uploaded image file as the logo to be associated with the selected profile.

A user profile 118 may be utilized by a user on the current visit to the website and on future visits to the website. To utilize a user profile, the user navigates to a Studio web page on the website in which a design template comprising one or more fillable fields is displayed.

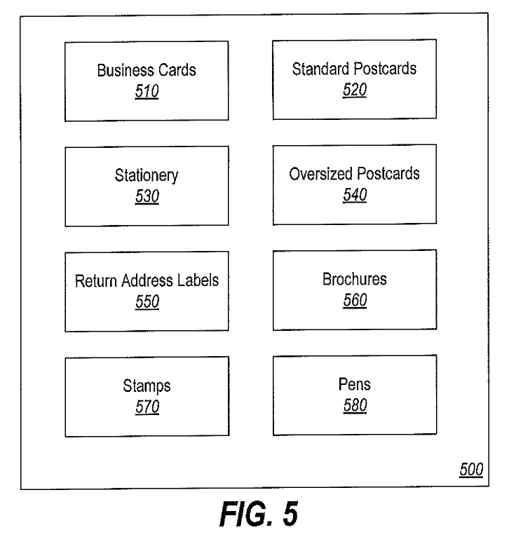

FIG. 5 is a representation of a web page 500 provided by an online vendor of customized and personalized products. As used herein, the term “customized product” refers to a product offered by a vendor that incorporates a graphical design that is designed, at least in part, by the user through the selection, editing, and/or manipulations of text, fonts, images, graphics, and/or colors of a pre-designed design. A “customized product design” refers to the design of a customized product wherein the design of the customized product is designed, at least in part, by the user through the selection, editing, and/or manipulations of text, fonts, images, graphics, and/or colors of a pre-designed design. As also used herein, a “personalized product” refers to a product offered by a vendor that incorporates in its design at least some information such as text and/or images that are personal or specific to the user. A “personalized product design” refers to a product design wherein one or more components in the design include at least some information such as text and/or images that are personal or specific to the user. A personalized product design can be a customized product design.

The page 500 displays and promotes various types of products available from the service provider and offers active controls that allow the user of UCS 100 to select a desired type of product for a more detailed presentation of design options. By way of example, FIG. 5 shows promotional images for business cards 510, standard postcards 520, stationery 530, oversized postcards 540, return address labels 550, and brochures 560, stamps 570, and pens 580. Images or promotions for additional products, such as presentation folders, invitations, announcements, thank you cards, gift tags, and so forth could also be presented on the screen along with other information and links. It will be understood that the invention is not limited to documents that are intended for eventual printing. The documents may also be electronic in their final form, such as electronic business cards, online brochures, websites, and templates for presentation graphics software programs. The customized designs may also be readily incorporated into to a wide range of products that a user may wish to customize, such as t-shirts, hats, and other items of clothing, product containers, promotional goods, and so forth.

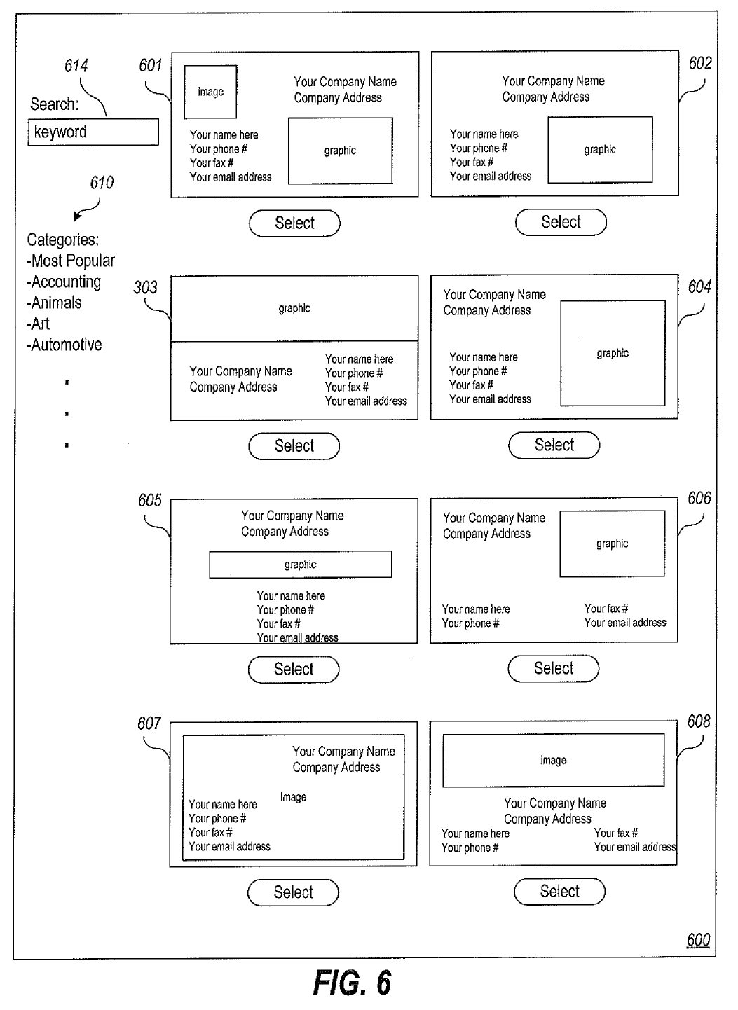

For the purpose of an illustrative example, it will be assumed that the user of UCS 100 desires to create a custom standard business card and, therefore, selects the standard business card option, for example by clicking with the user's mouse cursor on the link associated with the standard business card 510 image. In an embodiment the links are embedded in the image so that when the user interface detects a click event on the associated image, a page associated with the link is loaded in the browser. Alternatively, the link may be a button or text displayed in connection with the image. Referring to FIG. 6, in response to the user's selection, a page 600 directed specifically to standard sized business cards is retrieved from server 110 and displayed to the user. On this page 600, the user is presented with thumbnail images 601-608 of sample business card template designs. The service provider can choose to present more or fewer than images simultaneously, depending on available display space, the size of thumbnail images used, and the number of available template designs.

To give the user an indication of the types of business card template designs that are possible, the vendor may initially present the user with a number of pre-designed default template design examples 601-608 containing various combinations of images, graphics, colors and arrangements to give the user a range of visual appearances. To allow the vendor to present the user with candidate product templates that are relevant to the user's intended purpose for the cards, the page 600 may include a list 610 of selectable categories, wherein upon selection of a particular category (for example by clicking on the category link), a set of design examples relevant to the selected category are displayed to the user in place of the default design examples 601-608. Other types of selection means could be readily employed. For example, a tool 614 could be implemented as a search field where the user types in one or more terms to be compared with the keywords associated with stored images. Tools could also be implemented to contain additional filters for allowing the user to narrow the search according to certain image characteristics or content. For example, check boxes or another menu could be provided to allow the user to request templates with only photographic images or only illustrations.

One or more template designs 601-608 may include zero or more images. The number of image choices offered in a design may vary among the product types depending on the variety of layouts prepared by the vendor for each product type. For example, layouts for a relatively large product, such as an 8½ by 11 brochure could be designed by the vendor to contain a greater number of images than smaller products such as a business card or standard size postcard.

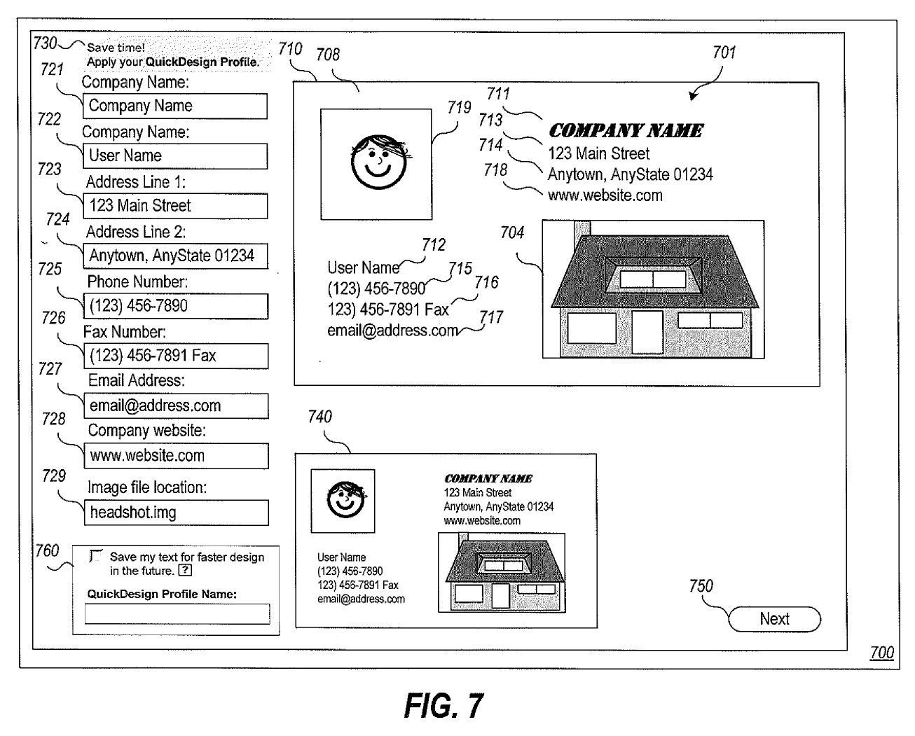

A user may select one of the template designs 601-608 or search for other template designs. Upon selection of one of the designs 601-608, the user is presented with a Studio web page, shown in FIG. 7, which allows the user to customize the selected template design (e.g., manipulate fonts, color schemes, and content), and to add personalized information.

A template design is a combination of a layout, color scheme, fonts, images, and editable fields. In one embodiment for example described in co-owned U.S. patent application Ser. No. 10/679,028, U.S. Publication No. 2005-0075746 A1, hereby incorporated by reference herein in its entirety, templates are constructed from a combination of separate components and attributes. Templates are separated into layouts, images available for placement in the layouts, fonts, and template color schemes. This approach allows candidate templates to be assembled dynamically using images that are associated with the keyword entered by the user and, therefore, are likely to be relevant to the user's interests.

In addition to images, many templates will have various additional elements, such as lines, shapes, and graphic elements. Each of these elements will typically have one or more associated colors. If fixed colors are assigned to these non-image elements, or if colors are assigned randomly, there is a likelihood that some images will have colors that are not visually compatible with adjacent colors, creating an unappealing template. Assigning colors to template components is, therefore, advantageously handled by way of a separately controlled template color scheme. Techniques for defining and using color schemes are well known in the art.

To facilitate image and layout modularity and combinability, all layouts are designed with standard pre-defined image container sizes and all images are made available in at least some of the same standard sizes. The number of different standard image containers used and the exact size of each container is a discretionary choice of the vendor or other template creator.

In addition to images, templates will also typically include one or more fields whose values may be filled in with user specific information to personalize the product design. For example, the design template may incorporate any of the fields that may be filled out in the user profile.

Referring again to FIG. 6, to select a desired template, the user clicks on a Select button associated with the desired template design to arrive at the next screen—a Studio page 700 as shown in FIG. 7. As depicted in FIG. 7, the Studio page 700 includes a design work space 710 where a design image 701 may be designed. In this example, the design image 701 is the combination of an image container containing a graphical image 704 depicting a logo image, another image container containing a secondary image 719, and several pre-defined text containers 711-718 containing default text displayed on a background 708. In the depicted example, the online vendor has initially filled the text containers 711-719 with the placeholder text “Company Name”, “User Name”, “Address Line 1”, “Address Line 2”, “Phone”, “Fax”, “E-mail”, and “Web Address”, to give the user an indication of the relative size and location of where and how the user's text entries will appear.

The product design page 700 may also include a product image 740. Product image 740 depicts the selected product in combination with the design image 710 and indicates the appearance of the finished printed product. While the design image 701 in the work space 710 is editable, allowing the user to select and edit the text and image containers 711-719, the product image 740 is not editable and merely depicts the final product having the design incorporated into the product. When the product is a business card, as in the illustrative example, the product image 740 may be identical in appearance to the editable design 710. However, when the design in the work space 710 is to be printed on or otherwise incorporated as only part of another product, such as in the case of printing the design onto a t-shirt or hat, the advantage of displaying the product image 740 will be more apparent. In FIG. 7, product image 740 is an image of a business card, corresponding to the product being customized with the user specified information.

In one embodiment, each of the text and image containers in the template is directly editable in the work space 710. Alternatively, or in addition, text entry fields 721-728 may be provided outside of the work space 710 to allow the user to customize the text entries of the corresponding text images appearing in the design shown in the work space 710. The text entered by the user may include letters, numbers, punctuation marks or other symbols as supported by the vendor and/or site operator. All characters of all types entered by the user are collectively referred to herein as “text”. Images corresponding to the user's text are created at server 110, returned to UCS 100 and rendered by tools 106 at the appropriate locations 711-718 in the design, as dictated by the respective locations of the corresponding text containers in the design work space 710.

As described previously, when the user enters text in the text entry fields 721-728, or directly edits the text containers containing the text for the text images 711-718, the edits are sent to the server 110 which re-renders the design and returns the updated product image 740 to the UCS 100 for display to the user.

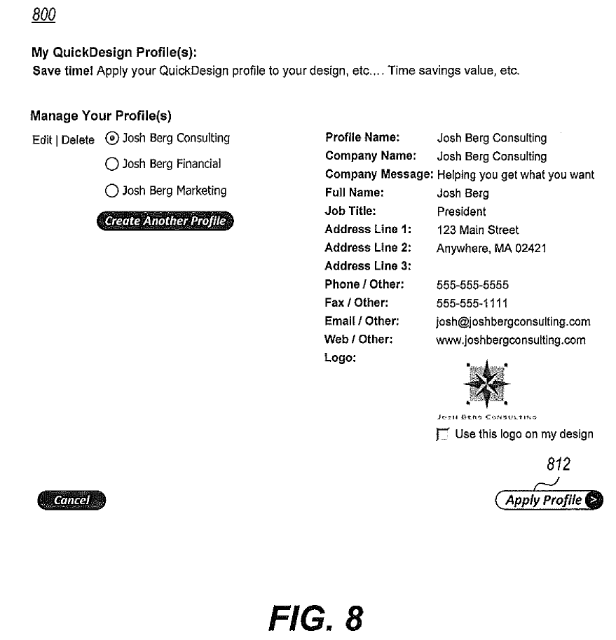

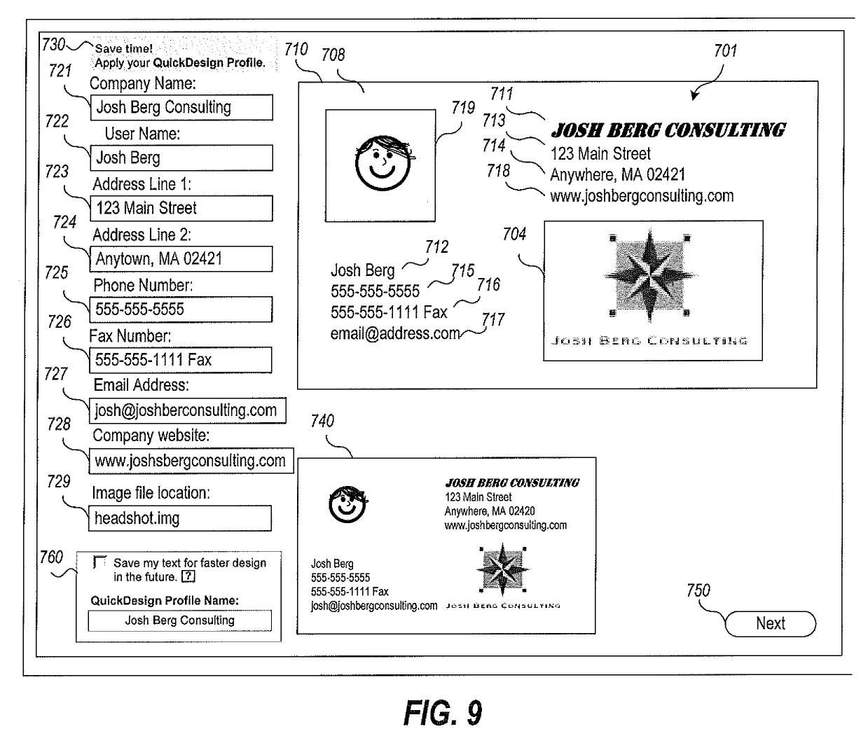

Instead of editing each of the text entry fields 721-728 or text containers 711-718 in the work space 710, the Quick Design User Profile tool of the present invention allows the user to select a profile in the Studio page to have the design tool 106 or server 110 automatically fill in all of the relevant fields in the selected template design with corresponding field values from the selected user profile. In the Studio page 700, a user profile import control 730 is provided which, when activated (for example by clicking on a control button or link), pops up a Quick Design User Profile management window 800, shown in FIG. 8. The Quick Design User Profile management window 800 includes the profile selection tool 301 (same as in FIG. 3) which displays the list of user profiles available for selection. The user can select one of the available profiles, and the corresponding field values are displayed in the window 800. The management window 800 also includes an Apply button 812, which when clicked or otherwise activated, causes the design tool 106 or server 110 to automatically, without further user intervention, fill in values of fields of the selected template design of FIG. 7 with the field values of corresponding fields of the selected user profile. FIG. 9 is a screen shot which displays the Studio page 700 after a user has selected and applied a user profile. As illustrated, each of the text entry fields 721-728, text containers 711-718 and logo image container 704 in work space 710, and product image 740 is updated to display the design template with user profile information incorporated therein.

Alternatively, if the user had not yet saved a user profile, the user must edit all of the text and image entry fields 721-729 to personalize the template design with the user's desired personal information. In the Studio page 700, a Quick Design User Profile control 760 is also provided to allow the user to save a user profile 118 for future use. If the control is activated, the user is taken to the New User Profile Data page 400 shown in FIG. 4, whereby the field values 421a-421k are automatically and without any further action on the part of the user pre-populated with the field values in the text entry fields 721-728 which correspond to the same field names. The user can fill in field values for any empty fields and/or edit others of the field values. Once the user is satisfied with the information inserted into the field values of the user profile, the user can then save the profile and apply it to future designs, as previously described. Thus, other than the user selection of the desired user profile and the activation of the Apply Profile control, the design template is automatically personalized with the information from the user profile without any action by the user.

While the functionality for updating the image of the design to include the applied user profile is described as being implemented at the server, such functionality can also be implemented within the design tool itself.

After the user has edited the design of the product in the Studio page 700, the user presses the Next button 750. Additional web pages may be presented to the user, such as selection/design of a back side of the business card, optional accessories and offers.

Many users of customized products desire to use matching products that present a consistent image to the public, such as business cards, letterhead, return address labels, notecards, sticky notes, pens, t-shirts, websites, and other materials that are visually consistent in image, graphics, color scheme, fonts, and other features. Vendors that make available matching products generally seek efficient and productive ways to promote to its customers the vendor's other matching product offerings.

For example, co-owned and co-pending U.S. application Ser. No. 11/082,543, entitled “Matching Product Marketing System and Method”, filed Mar. 17, 2005, incorporated herein by reference for all that it teaches, details a system which allows a product vendor to automatically generate reorder reminders or matching product solicitations to its customer base.

In another example, in co-owned and co-pending U.S. application Ser. No. 10/255,531, entitled “Supplemental Product and Method”, filed Sep. 26, 2002, incorporated herein by reference for all that it teaches, vendors may offer matching customized products during the ordering and/or checkout process of another customized product. Thus, a user ordering a set of business cards may be offered a set of matching return address labels or letterhead customized with the user's custom design during the checkout process.

Vendors of matching products desire to present such products to a customer in such a way as to effectively promote the vendor's other matching product offerings so as to enable the user to quickly and easily order additional marketing materials incorporating matching designs for presenting a consistent image to the public.

In an embodiment, at least one web page is presented to the user offering matching customized products—that is, images of personalized product designs incorporating information from the selected user profile may be generated automatically and without user request and displayed on a web page to offer the user the opportunity to order one or more different personalized products. Because a user profile is selected, the matching products generated by the matching engine will appear with the user profile information incorporated therein. Since some products do not utilize all of the user profile fields, this can cause a problem in the matching engine in placing text content relevant to the user. For example, if a user designs a sticky notes pad that contains only the Company Name and logo, without the user profile stored, the matching engine could not automatically create business cards for the user because most of the field values required for designing a business card would be unknown. However, if the user stores a user profile, the matching engine then has all of the information it requires to create the business card, resulting in better matching products presentation for the user.

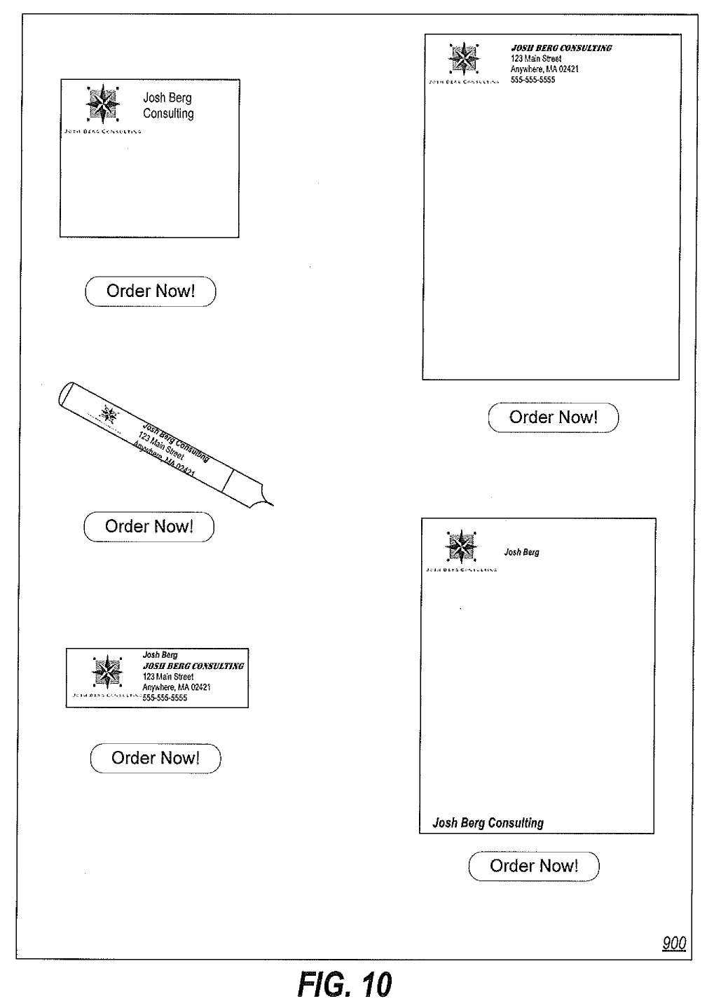

FIG. 10 depicts an illustrative embodiment of a matching products page 900 presented to the user, preferably during the ordering/checkout process of a customized product, which displays a number of matching products created specifically for the user according to the user's selected profile and containing personalized information from the user profile. Preferably, the matching products presented on the page 900 also match in at least some of the template design content, such containing one or more of the images utilized in the template design, matching the color scheme and fonts of the template design, etc. Preferably, at least one control on the matching products page 900 allows the user to find out more information about a product offered as a matching customized product and to order such product.

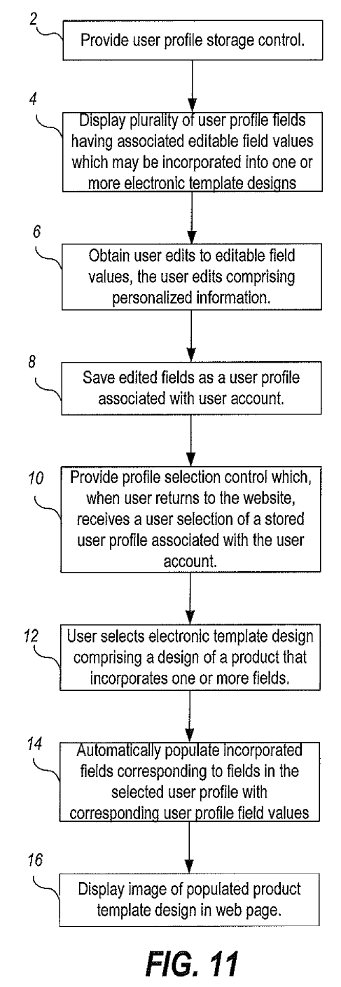

FIG. 11 illustrates an exemplary method for allowing users of one or more design tools at a website to store a user profile for auto-population of customizable data containers of design templates. As illustrated, the method includes providing a user profile storage control on a web page (step 2). When activated by a user of the website, the control causes a plurality of fields having associated editable field values which may be incorporated into one or more electronic template designs to be displayed (step 4). The control obtains user edits to the editable field values, the user edits comprising personalized information corresponding to the field names (step 6). The control saves the edited fields as a user profile associated with a user account (step 8).

The control provides a profile selection control which, when a user returns to the website, receives a user selection of a stored user profile associated with the user account (step 10), and upon selection by the user of an electronic template design comprising a design of a product that incorporates one or more fields (step 12), causes the incorporated fields corresponding to fields in the selected user profile to be automatically populated with the corresponding field values (step 14) and an image of the populated product template design to be displayed to the user on a computer display (step 16).

In summary, QuickDesign User Profiles provide a way for users to save time when designing custom personalized products on a website. Users save information that they would ordinarily type into the different fields in a Studio page (i.e. Name, Business Name, Phone #, Website, etc.) into different profiles corresponding to their different businesses or different users of the account (i.e. Joe's Plumbing Profile, Joe's Consulting Profile, etc.). Once a profile is created, a user has the ability to apply that stored information to a design template by selecting the appropriate profile in their account and clicking “Apply User Profile” in the Studio. Clicking this button causes the Studio or the server to auto-populate the appropriate fields in the selected template design with the correct information by matching the field name in the user profile to the field name in studio (i.e. the “name field” in the profile will populate the “name” field in studio).

The Quick Design User Profile described herein is advantageous for several reasons. First, if a user creates more than one design of one or more products but the personalized information is always the same, the user is not required to enter the personalized information (e.g., company name, name, title address, phone and fax numbers, logo image, etc.) for every design. The information need only be entered once, and can be reused for all future designs associated with the same personalized information. This can save quite a bit of time, and assists in eliminating typographical errors by reducing the amount of information actually typed in by the user.

In addition, because the system allows multiple user profiles to be associated with a user account, it simplifies the creation of designs for multiple intended recipients of the designed products. For example, the user of the account could be a marketing materials designer having multiple clients. The user could create a different user profile for each client, enter the client information once, and then create multiple marketing products for any of the clients without having to re-enter any of the client information.

The Quick Design User Profile also assists the website server in creating matching product designs to display to a user to assist the user in developing a coordinated branded image across multiple products. For example, if a user first designs a business card and creates a user profile, filling in all (or most) of the profile fields, the server may utilize information about the selected template to select a coordinating template for other products (such as, for example, pens, return address labels, postcards, etc.,) and automatically fill in the field values in the coordinating template according to the user profile field values. An image of the automatically created coordinating product design can then be presented to the user for potential ordering. This assists both the product vendor in cross-selling other products, and also assists the user in developing a coordinated branding system without any additional effort on the part of the user.

While the invention has been described in various exemplary embodiments, the described embodiments are to be considered as illustrative rather than restrictive. The scope of the invention, therefore, is as indicated in the following claims and all equivalent methods and systems.

What is claimed is:

1. A computer implemented method for allowing users of one or more design tools at a website to store a user profile for auto-population of customizable data containers of design templates, comprising:
providing a user profile storage control on a web page which, when activated by a user of the website, displays a plurality of fields having associated editable field values which may be incorporated into one or more electronic template designs, and which allows the user to edit the editable field values to include personalized information and to save the edited fields as a user profile associated with a user account;
storing one or more user profiles created using the user profile storage control such that when a user returns to the website, the user may select to utilize a stored user profile associated with the user account such that upon selection of an electronic template design comprising a design of a product that incorporates one or more fields, the incorporated fields corresponding to fields in the selected user profile are automatically populated with the corresponding field values and an image of the populated product template design is displayed to the user on a computer display.

2. A computer implemented method for automatically populating fields in an electronic template design displayed on a web page of a website in a browser executing on a user's computer, a server hosting website associating the user with a user account, comprising:
displaying a template design, the template design comprising a plurality of fields having corresponding editable field values;
providing a user profile import control on a web page which, when activated by the user, displays one or more available user profiles associated with the user's account and which receives a selection of one of the available user profiles and automatically and without further action by the user populates fields of the template design with field values of corresponding fields of the selected user profile.
